(19) United States
(12) Patent Application Publication
(10) Pub. No.: US 2013/0324231 A1
(43) Pub. Date: Dec. 5, 2013

(54) ELECTRONIC ATTENDANCE CHALLENGE

(71) Applicant: Tomas Magalhaes, Porto (PT)

(72) Inventor: Tomas Magalhaes, Porto (PT)

(73) Assignee: CRONOBITS LDA., Porto (PT)

(21) Appl. No.: 13/984,874

(22) PCT Filed: Feb. 15, 2011
(86) PCT No.: PCT/IB11/50624

§ 371 Date: Aug. 12, 2013

(51) Int. Cl. A63F 13/00

(52) U.S. Cl. CPC A63F 13/00
USPC 463/25

(57) ABSTRACT

A method and system for providing participants 14 with attendance challenges having time windows for action 24 in which the participant 14 must take action are provided. The method and system provide a means for the participant to meet the attendance challenge 32, and a reward 36 if the challenge is met. In one embodiment, the participant 14 is provided with a time window for action 24, and the electronic attendance challenge system 10 must receive a check-in signal 32 from the participant 14 within the time window for action 24 in order for the participant 14 to win. The participant 14 may accomplish this by logging-on to a website 100 and signing in using a unique identifier 22 to meet the challenge and win an award.

### TECHNICAL FIELD

The present disclosure is related to electronic gaming methods and systems.

### BACKGROUND OF THE INVENTION

An electronic game is a game that employs electronics to create an interactive system with which a participant can play. Online games are electronic games played over some form of communications system, such as being hosted by a game server over the Internet. Electronic gaming requires technology; a system to host the game, mechanisms for connecting players together, and algorithms to process electronic data.

A single player online game is an electronic game in which the participant plays against oneself or a host. The single player online game is hosted by a host server typically at a different location from the participant. A multiplayer online game is an electronic game in which participants may play with other participants from all around the world. In a multiplayer online game, usually participants play against each other rather than the house.

A stand-alone arcade game, also known as a gaming kiosk, is a system that provides an electronic game to the participant at the physical location of the participant. Typically arcade games have been located in places such as public businesses, restaurants, hotels, and video arcades. Arcade games are generally coin-operated; they require some form of money or credit to play. Some arcade games use coins or tokens, while others accept bills and swipe cards.

Participants may sometimes wager on the outcome of a game. In a single player game the participant wagers against themselves or against a host. In a multiplayer game the participants wager against one another. A betting pool allows participants involved in a multiplayer game to pay a fixed price into a pool, and then make a selection on some outcome. The pool is usually evenly divided between those that have made the correct selection.

An electronic database is a device that can store and organize data providing for easy retrieval. It typically consists of an organized collection of data for one or more uses, usually in digital form. A server is a software framework dedicated to the execution of procedures (programs, routines, scripts) for supporting the construction of applications. A server is often used to access a database.

The following references are related to this application: U.S. patent application No. 2010/0019453 to Oakes et al., U.S. patent application 2007/0129123 to Eryou et al., U.S. patent application 2009/0017905 to Meckenzie et al., and U.S. patent application 2010/0029376 to Hardy et al.

### SUMMARY OF THE INVENTION

A method of providing participants with attendance challenges is provided. In one embodiment, a system allows the participant to choose a time window in which the participant is required to take action. In another embodiment, the system chooses the time window for action for the participant. In either embodiment, the system provides a means for the participant to check-in, such as by logging-on to a website and signing in using a unique identifier to prove who they are. In this scenario, the time the participant logs-on must be within the time window for action in order to win the challenge.

In still another embodiment, the system has a database, or equivalent memory storage unit, which stores participant profile data and associated attendance challenge data. In this embodiment, the participant profile data includes the unique identifier and the attendance challenge data includes the time window for action. When the participant checks-in during the time window for action, the system receives the check-in signal containing the unique identifier and processes the check-in signal by utilizing an algorithm.

The algorithm in this embodiment causes a time to be recorded when the check-in signal is received, and using the database determines whether the recorded time of the check-in signal is within the time window for action. In other words, in this embodiment the system verifies if the participant has checked-in within their time window for action.

In a further embodiment, if the participant did check-in within the time window for action, the system generates an in-attendance result and stores the in-attendance result as data in the attendance challenge data of the database. This data in the database may be used to provide participants with a reward for achieving an in-attendance result within the time window for action. Thus the participant must check-in within the time window for action in order to be rewarded.

In yet further embodiments, the participant may play against themselves, against a host, or against other participants.

### BRIEF DESCRIPTION OF THE DRAWINGS

FIG. 1 is a diagram illustrating an electronic attendance challenge system in communication with a communication system embodiment;

FIG. 2 is a block diagram flowchart illustrating an attendance challenge set-up procedure embodiment;

FIG. 3 is a block diagram flowchart illustrating a check-in procedure embodiment;

FIG. 4 is a block diagram flowchart illustrating a reward calculation embodiment for a multiple participant attendance challenge;

FIG. 5 is a block diagram illustrating an embodiment in which the electronic attendance challenge system is accessed through a website on the Internet; and

FIG. 6 is a diagram illustrating possible modes for communicating with a communication system as envisioned in this disclosure.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

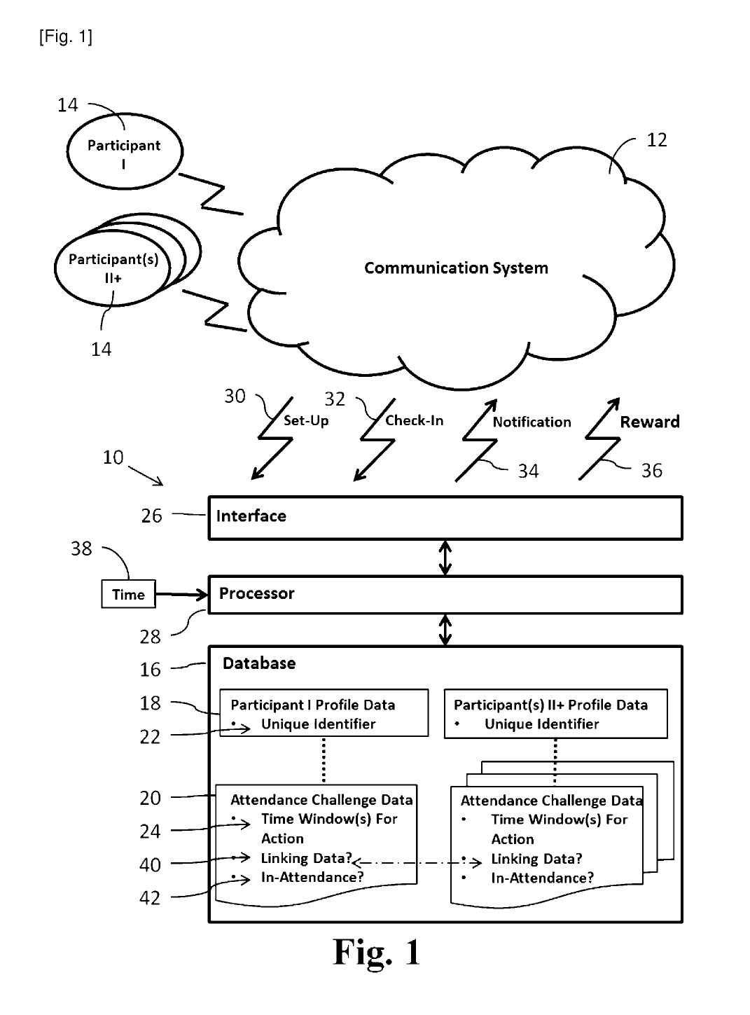

In regards to FIG. 1, an embodiment of the electronic attendance challenge system 10 is shown in communication with a communication system 12 and one or more participants 14. The electronic attendance system 10 has a data management subsystem providing a database 16 which stores one or more sets of participant profile data 18 and one or more sets of associated attendance challenge data 20. The participant profile data 18 includes a unique identifier 22 and the attendance challenge data 20 includes a time window for action 24.

In this embodiment, the electronic attendance system 10 also has an interface 26 capable of sending and receiving signals from the communication system 12 and a processor 28 capable of executing various algorithms. In the figure, the interface 26, processor 28, and database 16 are shown connected in close proximity, however, the three components need only be in communication with one another and may or may not be housed in a single location.

A specific communication system 12 is not required to practice the invention, as long as the proper system hardware is configured to interact with whatever communication system is used. One skilled in the art may choose from varying compatible technologies such as, but not limited to, satellite telecommunication systems, cellular telecommunication systems, the Internet, and radio frequency communication systems, to name a few. In furtherance of this concept, connections between the participants 14, the communication system 12, and the electronic attendance system 10 need not be specified. The connections between the internal components, the interface 26, the processor 28, and the database 16, need not be specific either. As examples of such, one skilled in the art may connect the entities and components by hard wire, such as by telephone lines or Internet cables, or wirelessly, such as by radio frequency, infrared or Bluetooth technologies.

FIG. 1 shows the electronic attendance system 10, through the interface 26, receiving set-up signals 30 and check-in signals 32 from the communication system 12, as well as sending notification signals 34 and reward signals 36 to the communication system 12. When a signal is received by the interface 26, it is communicated to the processor 28 and depending on the signal, the processor executes the proper algorithm. Additional signals not shown here may be received, processed and sent based on programming utilized by the processor 28.

It is envisioned that the electronic attendance challenge system 10 could communicate through signals in a variety of different forms. Illustrative examples of the different forms would include data transfer in the form of text sent to and received from a receiving unit accessible by the participant 14, such as a pager or cell phone, data transfer in the form of a visual display, such as the participant 14 using a computer to access a webpage, and data transfer audibly such as utilizing an automated voice response system over a telephone. However, signals received and sent by the electronic attendance challenge system 10 to the participant 14 could be done in anyway known to man now or in the future.

As shown in the embodiment in FIG. 1, the processor 28 is also in communication with a device that can provide the time 38. This may be accomplished in a number of different ways; either by using an internal clock within the electronic attendance challenge system 10, by accessing time from the Internet, or by accessing the atomic clock time as used in television broadcasts, and in global navigation satellite systems.

FIG. 1 also shows that the database 16 is capable of maintaining additional data such as linking data 40, which links two or more participants 14 to the same attendance challenge, and in-attendance results 42 from successfully met time windows (more on this below).

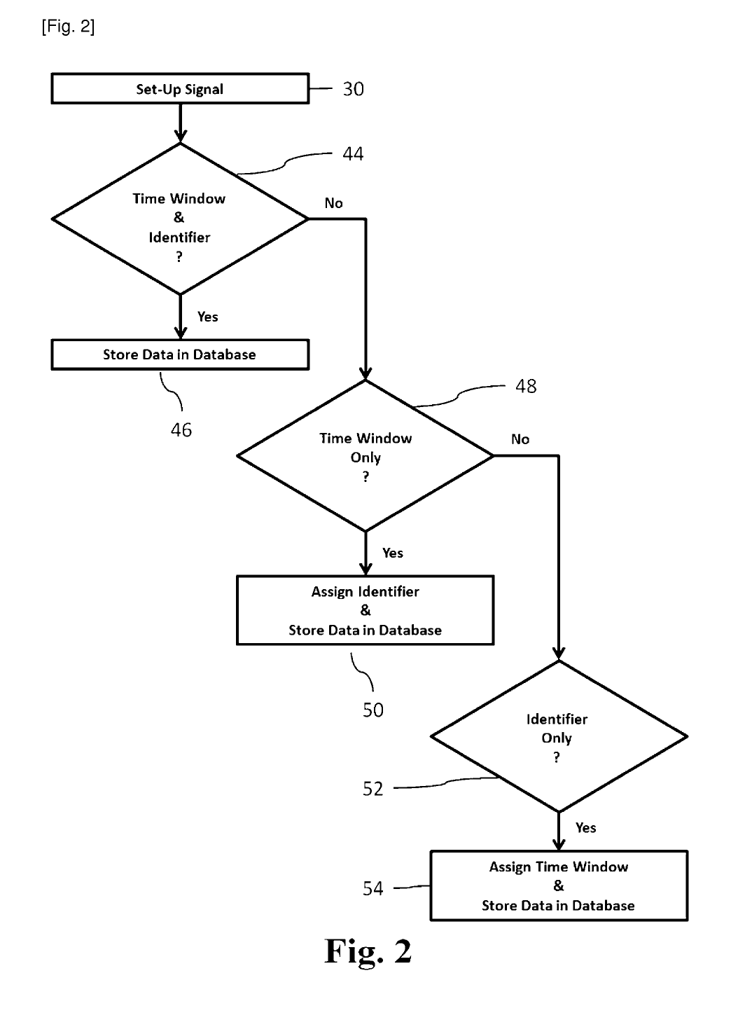

In regards to FIG. 2, an embodiment is shown illustrating how the processor 28 processes a received set-up signal 30. In this embodiment, the processor 28 is capable of three different scenarios. The first set-up scenario 44 is one in which the set-up signal 30 contains both the time window for action 24 that the participant wishes to attempt and the unique identifier 22 that the participant will use to identify themselves when, and if, they check in within the time window. In this case, the processor simply performs a first set-up step 46 by executing a program that will save the data in the database 16.

The second set-up scenario 48 is one in which the set-up signal only contains the time window for action 24 that the participant wishes to attempt. In this case, the processor performs a second set-up step by executing a program which assigns a unique identifier 22 to the participant and saves the data in the database 16.

The third set-up scenario 52 is one in which the set-up signal only contains the unique identifier 22 that the participant will use to identify themselves when, and if, they check in within the time window. In this case, the processor 28 performs a third set-up step 54 by executing a program that will assign a time window for action 24 to the participant and save the data in the database 16.

In the embodiment shown in FIG. 2, it is envisioned that the processor 28 may execute a program that will send a notification signal 34 from the electronic attendance challenge system 10 to the participant containing the assigned data. The processor 28 may also execute a program to send a notification that the data has been saved. The notification signals may be accomplished by sending an audible signal from a recording or synthesized speech program, or by visual signals such as text on a visual display as discussed above. In addition to the containing the assigned data, the notification signal 34 may contain an advertisement for the participant.

In an additional embodiment, in the case of the third scenario 52 where the tie window for action 24 is to be assigned to the participant, the notification signal 34 containing the time window for action 24, or second set-up signal, is not sent until the opening of the time window. In this embodiment, the time window for action may be as small as five or ten minutes, and the participant 14 would have to send a check-in signal 32 before the time window closes.

It should also be noted that in another embodiment of the invention, the participant 14 does not provide any of the data stored in the database 16, rather the data is provided by another source. As well, the participant 14 may not be sent a notification signal 34 and the assigned data may remain hidden from the participant 14, such that participant takes a random chance of attaining an in-attendance result 42 for the challenge.

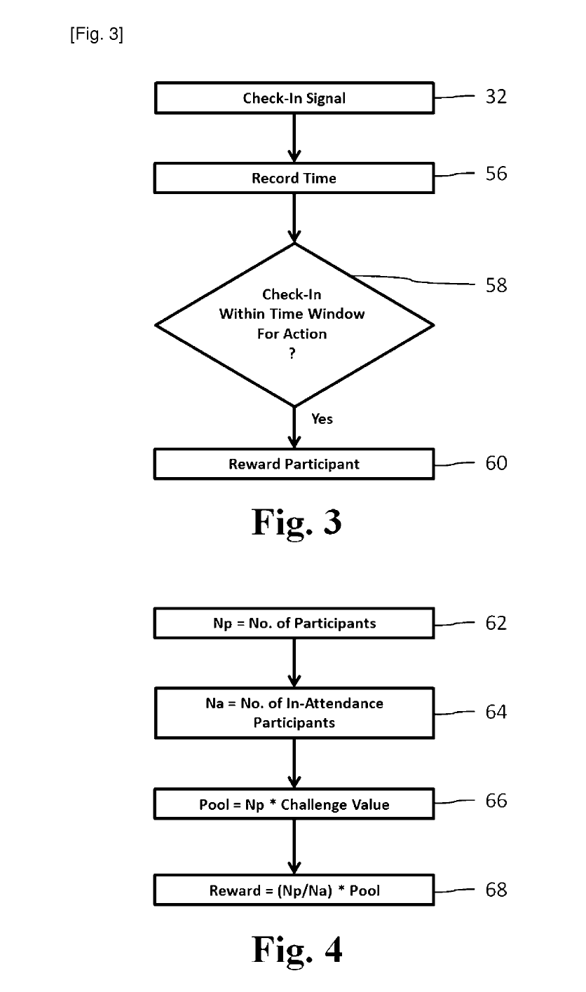

In regards to FIG. 3, an embodiment is shown illustrating how the processor 28 processes a received check-in signal 32. In this embodiment, the processor 28 executes a program which initiates a first check-in step 56 to record the time 38 at which the signal was received and a second check-in step 58 to compare the time 38 with the time window for action 24. If the check-in signal 32 is received within the time window for action 24, the processor 28 executes a third check-in step 60, rewarding the participant 14 for meeting the time window attendance challenge.

In a greater specificity embodiment of the above embodiment, the interface 26 receives a check-in signal 32 containing a unique identifier 22. The interface 26 communicates the check-in signal 32 to the processor 28, and the processor executes an algorithm within the data management subsystem 16. The algorithm determines a check-in time 38 for the check-in signal 32, and utilizing the unique identifier 22 accesses the corresponding participant profile 18 in the database 16. From the participant profile data 18, the algorithm accesses associated attendance challenge data 20 to determine if the participant has a time window for action 24. If the participant has a time window for action 24, then the algorithm determines if the time 38 the check-in signal 32 was received is within the time window for action 24. If the time 38 the check-in signal 32 was received is within the time window for action 24, then the algorithm generates an in-attendance result 42 (as shown in FIG. 1) and saves the result in the attendance challenge data 20 in the database 16.

If the attendance challenge is a single time window, single participant attendance challenge, then the participant has met the attendance challenge and is provided a reward 36 (as seen in FIG. 1). Before providing the reward 36 to the participant, the electronic attendance challenge system 10 may send a notification signal 34 to the participant 14 indicating the in-attendance result 42. The notification signal 34 may contain information on how to accept the reward 36, or provide different options to the participant for using the reward 36. The notification signal 34 may also contain an advertisement for the participant 14.

It is also envisioned that a number of participants 14 may compete against each other in an attendance challenge. In this embodiment, the reward 36 would be a function of the number of participants 14 involved in the attendance challenge and the number of participants 14 achieving an in-attendance result 42.

In a multiple participant attendance challenge, each participant 14 may choose, or be assigned, the same time window for action time 38, thereby requiring all participants 14 involved in the multiple attendance challenge to check in at the same time. Alternatively, each participant 14 could choose, or be assigned, a different time window for action 24, thereby requiring the attendance challenge to remain open until the close of the last participant's 14 time window for action 24. Thus, in this embodiment, an in-attendance result 42 would indicate that the participant is a winner, but it would not indicate what the reward 36 would be if the reward is a function of the number of winners until the end of the attendance challenge.

In a greater specificity embodiment of the above embodiment, during the setting up of the attendance challenge, the participant 14 would choose a multiple participant attendance challenge, and the processor 28 would execute a program to store linking data 40 (shown in FIG. 1) linking the participants involved in the challenge.

When the electronic attendance challenge system 10 receives a check-in signal 32, the processor 28 executes a program to determine if the participant 14 is in-attendance as described above. In addition, the program checks for linking data 40, and if there is linking data 40, the program utilizes the linking data 40 to determine if all of the time windows for action 24 involved in the multiple participant attendance challenge have closed. If there is a time window for action 24 still open, or yet to be opened, then the in-attendance result 42 is saved in the database 16 just as above. If all time windows for action 24 have expired, then the processor 28 executes a program to reward the participants 14 with in-attendance results 42.

In a further embodiment, the participants 14 receiving an in-attendance result 42 in a multiple participant attendance challenge receive a reward 36 that is a function of the outcome of all of the participants involved with the multiple participant attendance challenge. In this embodiment, the multiple participant attendance challenge is provided with a challenge value per participant 14, such as $1.00 per participant. The challenge value may be provided by the host, a third party non-participant, a third party participant, or each participant.

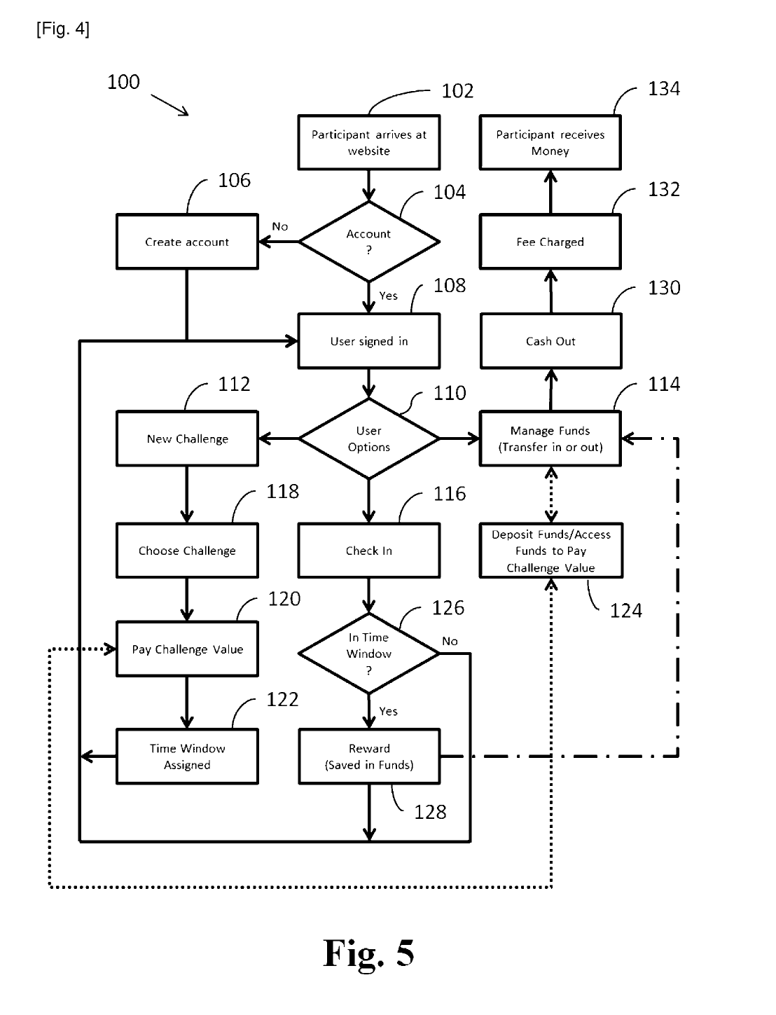

In regards to FIG. 4, an embodiment is shown illustrating how the processor 28 processes a reward 36 in a multiple participant attendance challenge. Upon the completion of a multiple participant attendance challenge (when the last time window for action 24 closes), and by utilizing the linking data 40 in the database 16, the processor 28 executes a first variable calculation 62 to determine the number of participants 14 involved in the multiple participant attendance challenge (Np). The processor 28 executes a second variable calculation 64 to determine the total number of participants 14 in the multiple participant attendance challenge that have an in-attendance result 42 for that multiple participant attendance challenge (Na). The processor 28 executes a third variable calculation 66 to determine the total pooled amount of the multiple participant attendance challenge by multiplying Np by the challenge value (Pool). The processor 28 executes a fourth calculation 68 to determine the reward 36 for the multiple participant attendance challenge by taking the ratio of the total participants 14 involved, Np, over the number of participants 14 with an in-attendance result 42, Na, and multiplying this quotient by the total pooled amount, Pool; Reward=(Np/Na)*Pool.

It should be noted that the rules of mathematics, in particular with multiplication and division, allow for these steps to be taken in any order, and any equation that combines the same steps in a different order would be considered equivalent.

As well, in an alternate embodiment, the pool amount may be a fixed total amount, such as $100.00, to be divided up by the winners. In this embodiment, the pool amount may be funded by posting an advertisement, and a percentage of the revenue earned by the host for posting the advertisement is provided to the pool to be divided up by the participants 14 that view the advertisement. Since the pool amount is fixed, the greater the number of viewers, the lower the reward.

Another embodiment of the invention requires participants 14 to have in-attendance results 42 for multiple time windows for action 24 in order to receive a reward 36. In this embodiment, the electronic attendance challenge system 10 requires at least one additional time window for action 42 for the participant 14, and the additional time window for action 42 is stored in the attendance challenge data 20. When receiving the check-in signals 32, the processor 28 executes a program to process the check-in signals 32 by utilizing an algorithm having the steps of:

1. Recording the time 38 each of the check-in signals 32 is received;

2. Accessing the database 16 and selecting the corresponding participant profile data 18 using the unique identifier 22,

3. Accessing the attendance challenge data 20 associated with the participant profile data 18, and determining whether the recorded time 38 of the check-in signals 32 are within the time window for actions 24;

4. Assigning a partial-attendance result and storing partial-attendance result data in the attendance challenge data 20 for each of the recorded times 38 of the check-in signals 32 within the time windows for actions 24; and

5. Processing a query within the attendance challenge data 20 to determine if all of the time windows for action 24 contain partial-attendance result data, and if so, assigning the in-attendance result 42 for the time challenge.

Another embodiment of the invention requires a team of participants 14 to all have in-attendance results 42 for their respective time windows for action 24 in order for the team to receive a reward 36. The reward may be divided up by all the team members or maintained in whole for use of the team. In this embodiment, the electronic attendance challenge system 10 requires that all participants 14 of a team must be in-attendance within their respective time windows for action 24 in order for the team to be in-attendance and win a reward. In order to provide this, the database stores team data combining a plurality of participant profile data 18. When receiving the check-in signals 32, the processor 28 executes a program to processing the check-in signals 42 by utilizing an algorithm having the steps of:

1. Recording a time 38 for each check-in signal 32 received;

2. Accessing the participant profile data 18 of each participant 14 by using the unique identifier 22 received with the check-in signal 32;

3. Determining if the participant 14 is part of a team challenge;

4. Determining the associated attendance challenge data 20 and the respective time window for action 24 for each participant 14;

5. Determining whether the recorded time 38 of the check-in signal 32 is within the time window for action 24;

6. Generating a partial-attendance result if the recorded time 38 is within the time window for action 24;

7. Storing the partial-attendance result data in the attendance challenge data 20 of the database 16; and

8. Processing a query within the team data to determine if all of the participants 14 of the team achieved a partial-attendance result, and if so, assigning the in-attendance result 42 for the team.

In order to provide participants 14 with enticing attendance challenges, it is envisioned that the more attendance challenges offered, the more likely a number of participants 14 will engage in the challenges. Thus, in another embodiment, the electronic attendance challenge system 10 further generates a number of attendance challenges, each with a corresponding time window for action 24, and storing the attendance challenge options in the database 16 as attendance challenge option data (not shown). The participant 14 may review the different attendance challenges by sending a preset-up signal (not shown) to the electronic attendance challenge system 10. Upon receiving the first pre-set-up signal containing a request to be notified of possible time challenge options, the processor 38 executes a program which processes the first preset-up signal by accessing the attendance challenge option data, pulling a number of attendance challenges and transmitting a notification signal 34, or second pre-set-up signal, containing the attendance challenges with corresponding time windows for action 24 for the participant 14 to review. It is from this list that the participant 14 may send a set-up signal 30 containing a time window for action 24 and a unique identifier 22 as seen in FIG. 2.

An additional embodiment envisioned to provide participants 14 with greater interaction is the ability to provide attendance challenge statistics. In this embodiment, the participant may send a statistics request signal (not shown) to the electronic attendance challenge system 10 requesting various statistics about their account, their results, and all challenges in general. In this embodiment, the interface 26 would receive the statistics request signal containing a specific statistic request and the processor 28 would process a query in the database 16 to generate the requested statistics from the data in the database 16. The processor 28 could then transmit a notification signal 34, or statistics answer signal, to the participant containing the results of the query.

It is also contemplated that the system may provide the ability for one participant 14 to wager on the ability of another participant 14, or team of participants, to successfully complete an attendance challenge. As well, it is also contemplated that, if the specific attendance challenge allowed, participants 14 may buy and sell their spots in attendance challenges. This feature would allow a participant 14 who knew in advance that they would have an absolute conflict in meeting the attendance challenge to sell their spot in the attendance challenge to a replacement participant. This may be allowed at full challenge value, such that the replacement participant steps into the shoes of the original participant completely, or at a smaller value, such that the original participant would forfeit a percentage of the challenge value and the replacement participant could only win an amount equivalent to the percentage paid in as the replacing participant.

In another embodiment, the electronic attendance challenge system is capable of transmitting a notification signal 34, or check-in receipt signal, containing the recorded time the check-in signal is received to the participant. An advertisement could be included in this signal as well.

In another embodiment meant to aid the host of the electronic attendance system 10, the system further provides for sending notification signals 34 to participants 14 containing an advertisement before a set-up signal 30 has been received from the participant 14. The processor 28 after receiving the very first signal (not shown) from the participant 14 will execute a program storing the contact information connected to the first signal. The program may then generate an open participant profile data set 18 that may be filled by the participant 14 at a later date, if ever. The program may then transmit a notification signal 34, or a second signal, containing an advertisement to the participant 14 using the contact information in the first signal. The advertisement in this embodiment is best connected to a reward that can be achieved by playing the attendance challenge game and encouraging the participant 14 to send a set-up signal 30.

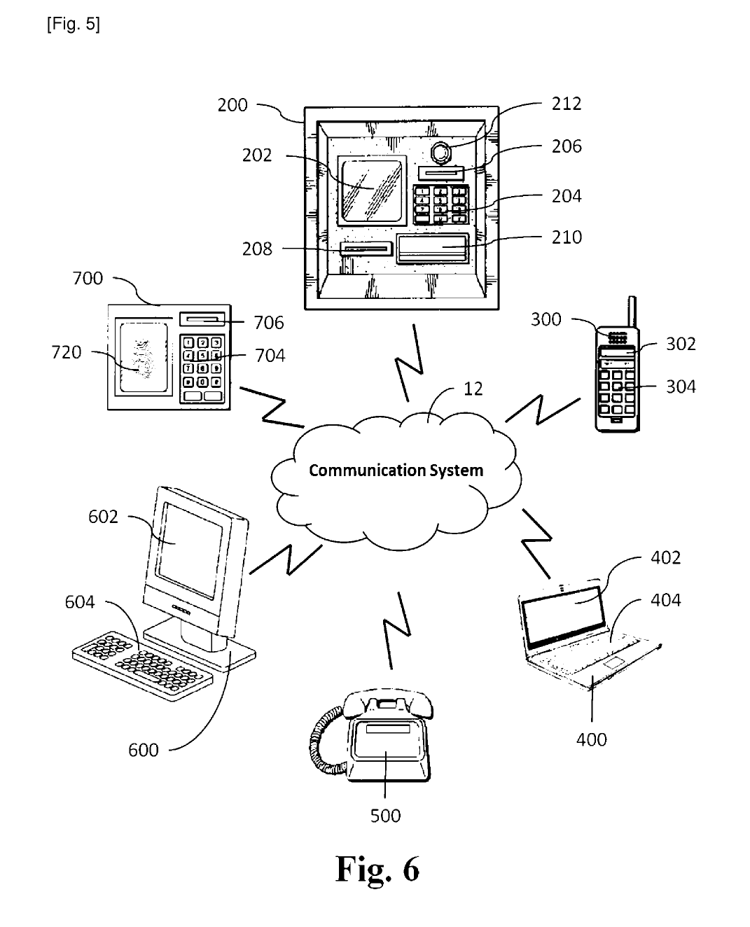

Another embodiment provides participants 14 with a way to cash out the reward 36. The electronic attendance challenge system 10 receives a first reward distribution signal (not shown) containing a desired amount of the reward 36 to be converted into real money. The processor 28 executes a program which processes the first reward distribution signal to determine a cash-out amount by assigning a real money equivalent to the reward and deducting a processing fee (as seen in FIG. 5 to be discussed below), and transmits the reward 36, or second reward distribution signal, containing the electronic equivalent of the cash-out amount.

A related embodiment provides participants 14 with the ability to provide a challenge value for each attendance challenge and maintain rewards. This embodiment requires a funds management account (see FIG. 5) within the electronic attendance challenge system 10 containing funds data (not shown) as an electronic representation of real money and associating the funds management account with the participant profile data 18 and/or attendance challenge data 20. This embodiment provides the participant 14 the ability to transfer their reward 36 to the fund management account and storing the reward as additional funds data. The interface 26 would receive funds management signals (not shown) containing instructions on the electronic transferring of funds, and the processor 28 would execute a program processing the fund management signals according to the instructions of the participant 14. The funds may be maintained in the funds management account, transitioned to represent a challenge value for additional attendance challenges, or cashed out (see FIG. 5).

In regards to FIG. 5, a diagram illustrating an embodiment in which the electronic attendance challenge system 10 is accessed through a website 100 on the Internet is shown. In this embodiment the participant 14 arrives at the main page 102 of the website 100 and is requested to log-in to their account 104. If the participant 14 does not have an account, the website 100 provides an opportunity to create an account 106. In the creation of an account, the database is populated with participant profile data 18. Depending on the desired electronic attendance challenge system 10, the unique identifier 22 of the participant may be saved in the database 16 at this time, or the unique identifier 22 may be saved when an attendance challenge is chosen. Whether a participant 14 had an account or just created an account, the participant is now signed in 108.

Once signed in the participant 14 has a number of user options 110. The participant may navigate to a page listing new challenges 112, navigate to a page to manage funds 114, or check-in 116. In another embodiment the participant may navigate directly to a check-in page 116 when they arrive at the website 102.

At the new challenge listings page 112, the participant 14 may choose a preexisting attendance challenge or create their own attendance challenge. If the attendance challenge is preexisting, the attendance challenge must have either a displayed time window for action 24, or a displayed challenge value (or potential reward). This page may also indicate a number of other attendance challenge features, such as if the attendance challenge is a single participant attendance challenge, a multiple participant attendance challenge, a multiple time window for action attendance challenge, or a team of participants attendance challenge, among others. If the participant 14 is allowed to create their own attendance challenge, then the participant may choose the time window for action 24, the challenge value, the reward, or any combination of these and the above listed features. The attendance challenges are fully customizable.

In further embodiments, the participant-created attendance challenges may be created as public or private challenges. Public challenges are accessible to any participant 14 with access to the website 100. Private challenges are only accessible by invited participants 14. In this embodiment, the system will allow the attendance challenge creator to invite additional participants 14 by sending an invitation signal (not shown) through the communication system 12 to the invited participants 14. Participants 14 not invited to a private attendance challenge would therefore either be able to see the private attendance challenge, yet not be permitted to participate in this challenge, or not be able to view the private attendance challenge at all. In the case of the former, the participant 14 may be able to contact the attendance creator to request permission to join the participant-created attendance challenge.

In yet further embodiments, the attendance challenge creator may invite additional participants 14 to the private attendance challenge. The selection of additional participants may include accessing the database 16 and selecting from participants 14 who are open to invitations from anyone, or by restricting access to participants 14 that are connected through a presorted group of contacts who allow invitations from the creator. Other options for invitation include sending invitation signals to additional participants 14 with instructions on how to access the website, create an account, and join the attendance challenge, or by utilizing an exterior database of contacts. The exterior database of contacts could include the connection to a social network or the access to any other database containing potential participants for the attendance challenge.

Once an attendance challenge has been chosen or created, the participant will be navigated to a confirmation page to choose the challenge 118. In this embodiment, the attendance challenge chosen has a challenge value 120 that the participant 14 must satisfy before going further. In other embodiments that do not require the participant to pay the challenge value, the website would navigate the participant 14 directly to the time window assignment page 122.

If a challenge value is required, the participant 14 may provide the challenge value either by depositing money into the funds account or by using funds already residing in the funds account. In either event, the website provides a back door 124 between the manage funds page 114, and the pay challenge value page 120. Once the challenge value is satisfied, the participant returned to the payment page 120 and is navigated to the assignment page 122 where a time window for action 24 is assigned. The challenge chosen may have already listed the time window for action as part of the challenge listings on page 112, or the participant learns of the time window for action 24 at this time, or the assignment is kept hidden from the participant 14, either to be transmitted at the beginning of the time window, or to be maintained hidden such that the participant 14 must use random luck in order to be in-attendance during the time window.

In an embodiment where the unique identifier 22 is to be different for each time window for action 24, the unique identifier 22 may be saved to the database 16 here as well.

Upon having a time window for action 24 assigned at the time window page 122, whether known or not to the participant 14, the website navigates the participant 14 back to the signed in page 108 and back to the user options page 110.

From the user options page 110, the participant may check in 116. The check in page 116 requires the unique identifier 24 to be sent in by the participant 14 to verify that the participant is indeed the one checking in. If the unique identifier is the participant's URL address, then the sending in of the unique identifier 22 may be automatic and unseen by the participant 14 when using the website. As well, if the unique identifier 22 is used to sign in, then the sending of the check-in signal may be automatic upon signing in to the website 100.

If the participant 14 checks in 126 outside of a time window for action 24, then the participant is navigated back to the signed in page 108 and subsequently back to the user options page 110. If the participant 14 checks in 126 inside a time window for action 24, then the participant 14 is navigated to a rewards page 128. If it is a single participant challenge, or if all of time windows for action 24 involved in a multiple participant attendance challenge have all closed, then the reward 36 is transferred to the funds management page 114. If there are outstanding time windows with an unknown remaining before the reward can be calculated, then the reward will be automatically deposited into the funds management page 114 at a later date. At this point the participant 14 is navigated back to the signed in page 108 and the user option page 110.

Other embodiments may also allow the participant 14 to navigate directly to the funds management page 114 with the reward 36. As well, the rewards page 128 as shown in this embodiment may only notify the participant 14 that they have achieved an in-attendance result 42, and the in-attendance result 42 is saved in the database 16.

Ultimately, the participant 14 is going to want to cash out some or all of their funds 130. In this embodiment, the host of the website charges an administration fee 132 at this time. In other embodiments, the administration fee may be charged when paying the challenge value, or there might not be an administration fee at all. In some embodiments, the reward may not be a monetary amount, in which the administration fee may be a separate charge to the participant included in shipping and handling or a processing fee. In other embodiments, a third party may pay the administrative fee for the participant 14. In the end, the participant 14 receives their reward 134, shown in this embodiment as real money.

In a similar embodiment, the electronic attendance challenge system 10 website 100 comprises a server (not shown), wherein the server contains the data management subsystem and the database 16, the processor 28, and the interface 26. In this embodiment, the communication system 12 is the Internet.

The unique identifier 22 employed in this invention can be any number of things which allow the electronic attendance challenge system 10 to recognize which participant 14 a check-in signal 32 is received from. Some basic examples could be a telephone number received through caller ID, or a computer URL address when a participant 14 signs on to a website. Other unique identifiers 22 would be things such as a personal identification number (PIN), a series of questions and answers, or an electronic key similar to that used in encryption software. In this case the PIN number, and series of questions and answers, could be chosen by the participant 14 or assigned by the electronic attendance challenge system 10 to the participant 14.

One desire of the system is to make it such that the individual participant 14 participating in the attendance challenge is the actual person sending the check-in signal 32. A more simple way to prevent participants 14 from setting up an automated check-in signal, is to use an anti-spider interface which requires a human user to read some jumbled letter and numbers and enter that into the website before checking in. In more advanced systems, the unique identifier 22 could be a biometric of the participant 14, such as using a camera and facial recognition software, a phone and vocal recognition software, or a finger print scanner.

In regards to FIG. 6, a diagram is shown illustrating a number of possible modes for communicating with a communication system. All of these modes are for examples only, and are not meant to limit the invention to other forms of communication.

FIG. 6 shows a kiosk 200 as a vehicle for the participant to access an electronic attendance challenge system. The Kiosk 200 may be a stand-alone kiosk containing the data management subsystem and database 16, the processor 28 and the interface 26 all inside its housing. The kiosk 200 may also be one of a number of kiosks 200 located at various locations, each with a means for sending the check-in signal containing the unique identifier to the interface through the communication system (as shown here).

The kiosk 200 embodiment here is a nice interface for the electronic attendance challenge system 10, as it provides a display 202, a keyboard or keypad 204, a credit card accepter 206, a bill acceptor 208, a payout slot 210, and a camera 212. The display 202 and keypad 204 provide the participant 14 with an easy way to communicate with the electronic attendance challenge system 10. The credit card slot 206 and bill acceptor 208 provide for an easy way to pay challenge values. The payout slot 210 provides an easy way to cash out and receive rewards. The camera 212 may provide security, but also may provide for facial recognition software as a unique identifier 22 for proving the participant 14 is in attendance for the challenge.

Also in FIG. 6, is a wireless phone 300, such as a cellular phone or satellite phone. The wireless phone has a display 302 and a keypad 304 which provide similar access to the electronic attendance challenge system 10 as the display 202 and keypad 204 of the kiosk 200. The wireless phone 300 perhaps offering the greatest mobility of all of the embodiments illustrated here. A laptop computer 400 with a display 402 and a keyboard 404, offering perhaps more interface opportunity than that of a wireless phone with similar mobility, but as smart phones continue to progress there may not be much difference between the abilities of the two. Also considered here are PDA's, pagers, palm computers, and tablets.

A desk phone 500 shown here with no keypad to illustrate that the electronic attendance challenge system 10 could employ automated voice response systems, and all communications between the desk phone 500 and the electronic attendance challenge system 10 can be audible. The participant 14 could speak a PIN number, or the system could use vocal recognition software as a biometric of the participant 14.

A desktop computer 600 with a display 602 and a keyboard 604 is also shown. The desktop computer 600 embodiment illustrates a less mobile restriction requiring participants 14 to be at home at their office where the desktop computer 600 resides. Desktop computers 600 traditionally have a fixed URL address, whereas laptop computers 400 URL addresses may change depending on where they are being used.

A fingerprint scanning unit 700 is shown with a keypad 704, a credit card slot 706, and a finger print scanner 720. Like the other embodiments, the keypad allows for easy communication between the participant 14 and the electronic attendance challenge system 10. The credit card slot provides for an easy way to manage funds as the challenge value may be charged to the credit card account and rewards may be paid to credit card account. The finger print scanner 700 may stand alone as a way for proving attendance at certain physical locations, or may plug into a wireless phone 300, a laptop computer 400, or a desktop computer 600 as a way to enhance those devices and improve access to all the features of the electronic attendance challenge system 10.

Finally, a reward 36 can be anything a person may find to hold value. Some specific rewards envisioned in this invention include, but are not limited to, a monetary amount, a non-monetary prize, a voucher, a credit, a coupon, a discount, a product, an object, a trip, a service, or a certificate. The following paragraphs give some examples of each of these rewards as illustrative examples to better understand the invention, but the invention is not limited to these specific forms of rewards.

Monetary rewards may be provided by the host, such that the participant's 14 receive advertisements during the competition and the advertising revenue funds the rewards. Monetary rewards may be provided by the participant in the form of a wager, in which the participants 14 who meet the attendance challenge take a portion of the pool and those participants 14 who do not meet the attendance challenge forfeit their wager.

The electronic attendance system 10 may be employed by a business and used to reward employees for logging in to work within a known time window for action 24, such as ten minutes before starting time, or a random time window for action 24 to reward those logged in at an important time of day. In this case, the business would provide the reward and pay a fee to the host of the electronic attendance challenge system 10 for providing the service.

The electronic attendance system 10 may be used by an elderly person who wishes to have family members call them on a regular basis. In this case, the time window for action 24 may be anytime within a week, and the attendance challenge may have multiple time windows for action 24. The elderly person could track which family member has the most in-attendance results 42 over the course of a year. In this case the elderly person may reward a non-monetary prize, such as a family heir-loom. The elderly person would pay the host for providing the service. In addition, the unique identifier 22 may be the phone number of the family members as provided by caller ID.

The electronic attendance system 10 may be used by a merchant who offers a voucher to be used to purchase goods. Such a voucher could be used at a physical goods location, such as a department store, or the voucher could be used online at other websites. In this embodiment, a participant 14 who meets the attendance challenge could use the reward 36 on a different website immediately or bank up a number of reward vouchers towards a larger purchase.

The electronic attendance system 10 may be used by an arcade such that winning participants are provided with credits that can be used to play other games. The arcade could be a physical location arcade, or an online arcade. These credits may be in the form of virtual tokens.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of providing participants with attendance challenges and rewards for meeting the attendance challenges, the method comprising:
providing a database which stores participant profile data and associated attendance challenge data, in which the participant profile data includes a unique identifier and the attendance challenge data includes a time window for action;
receiving a check-in signal containing the unique identifier;
processing the check-in signal by utilizing an algorithm having the steps of:
recording a time the check-in signal is received;
accessing the participant profile data using the unique identifier to determine the associated attendance challenge data and the time window for action;
determining whether the recorded time of the check-in signal is within the time window for action;
generating an in-attendance result if the recorded time is within the time window for action; and
storing the in-attendance result as data in the attendance challenge data of the database; and
providing participants with a reward for meeting the attendance challenge by achieving an in-attendance result.

2. The method of claim 1, further comprising:
receiving a set-up signal containing the time window for action and the unique identifier;
processing the set-up signal by utilizing an algorithm having the steps of:
generating the participant profile data by storing the unique identifier;
generating the attendance challenge data by storing the time window for action; and
associating the participant profile data with the attendance challenge data.

3. The method of claim 1, further comprising:
receiving a first set-up signal containing the time window for action;
processing the first set-up signal by utilizing an algorithm having the steps of:
generating the participant profile data by generating and storing the unique identifier;
generating the attendance challenge data by storing the time window for action; and
associating the participant profile data with the attendance challenge data; and
transmitting a second set-up signal containing the unique identifier.

4. The method of claim 1, further comprising:
receiving a first set-up signal containing the unique identifier;
processing the first set-up signal by utilizing an algorithm having the steps of:
generating the participant profile data by storing the unique identifier;
generating the attendance challenge data by generating and storing the time window for action; and
associating the participant profile data with the attendance challenge data; and
transmitting a second set-up signal containing the time window for action.

5. The method of claim 4, wherein the second set-up signal transmission is transmitted at the opening of the time window.

6. The method of claim 1, further comprising:
transmitting a notification signal to the participant containing the in-attendance result.

7. The method of claim 1, further providing advertisements to participants, the method further comprising:
receiving a first signal containing contact information;
storing the contact information in the participant profile data; and
transmitting a second signal containing an advertisement using the contact information.

8. The method of claim 1, wherein the reward is an electronic representation of real money.

9. The method of claim 1, further providing a plurality of participants to ability to participate in the same attendance challenge, the method further comprising:
wherein one of the attendance challenges is a multiple participant attendance challenge;
receiving at least two linking signals, each containing the unique identifier of the participant and selection data of the multiple participant attendance challenge;
processing each of the at least two linking signals utilizing an algorithm have the steps of:
generating linking data for the multiple participant attendance challenge by accessing each participant profile data using the unique identifier and corresponding the selection data of the multiple participant attendance challenge with each participant profile data; and
storing the linking data for the multiple participant attendance challenge in the attendance challenge data of the database.

10. The method of claim 9, further providing in-attendance participants to be awarded the reward as a function of the outcome of all of the participants involved with the multiple participant attendance challenge, the method further comprising:
assigning a challenge value to the multiple participant attendance challenge;
processing attendance challenge data within the database to determine the reward utilizing an algorithm having the steps of:
determining a first variable based on the number of attendance challenge data sets containing the linking data for the multiple participant attendance challenge;
determining a second variable based on the number of attendance challenge data sets with the in-attendance result stored for the corresponding attendance challenge;
generating a percentage by dividing the first variable by the second variable; and
generating the reward by multiplying the percentage by the challenge value.

11. The method of claim 1, further providing participants with a way to cash out the reward, the method further comprising:
receiving a first reward distribution signal containing a desired amount of the reward to be converted into real money;
processing the first reward distribution signal to determine a cash-out amount by assigning a real money equivalent to the reward and deducting a processing fee; and
transmitting a second reward distribution signal containing the electronic equivalent of the cash-out amount.

12. The method of claim 1, wherein the reward is a credit which may be applied toward purchases from another entity.

13. The method of claim 1, further providing participants with attendance challenges having multiple time windows for action, the method further comprising:
wherein the attendance challenge requires at least one additional time window for action, and the additional at least one time window for action is stored in the attendance challenge data;
receiving at least one additional check-in signal containing the unique identifier;
processing each of the at least one additional check-in signals utilizing an algorithm having the steps of:
recording the time each of the at least one additional check-in signals is received;
accessing the database and selecting the corresponding participant profile data using the unique identifier;
accessing the attendance challenge data associated with the participant profile data;
determining whether the recorded time of the at least one additional check-in signal is within one of the at least one additional time window for action;
assigning a partial-attendance result and storing partial-attendance result data in the attendance challenge data for each of the recorded times of the at least one additional check-in signals within the each of the at least one additional time windows for action; and
processing a query within the attendance challenge data to determine if all of the at least one additional time windows for action contain partial-attendance result data, and if so, assigning the in-attendance result for the time challenge.

14. The method of claim 1, further proving providing a team of participants within the attendance challenge, such that all participants of the team must be in-attendance within their respective time window for action in order for the team to be in-attendance, the method further comprising:
wherein the database has team data combining a plurality of participant profile data;
receiving a plurality of check-in signals each containing the unique identifier respective to each of the plurality of participants;
processing each of the plurality of check-in signals by utilizing an algorithm having the steps of:
recording a time the check-in signal is received for each of the plurality of check-in signals;
accessing the participant profile data using each the unique identifier respective to each of the plurality of participants to determine the associated attendance challenge data and the respective time window for action;
determining whether the recorded time of the check-in signal is within the time window for action;
generating a partial-attendance result if the recorded time is within the time window for action; and
storing the partial-attendance result data in the attendance challenge data of the database; and
processing a query within the team data to determine if all of the plurality of participant profile data and associated attendance challenge data associated with the team of participants contain partial-attendance result data, and if so, assigning the in-attendance result for the time challenge for the team.

15. An electronic system providing participants the ability to engage in time window attendance challenges, the system comprising:
a data management subsystem providing a database storing one or more participant profiles linked with a multiple participant attendance challenge, wherein each participant profile contains a unique identifier, and the participant profile is linked to the multiple participant attendance challenge which contains a participation value and a time window for action for each participant;
a processor in communication with the data management subsystem, in which the processor is capable of executing an algorithm;
an interface in communication with the processor, such that the interface is capable of receiving and sending signals; and
wherein if the interface receives a check-in signal containing the unique identifier, the interface communicates the check-in signal to the processor and the processor executes the algorithm within the data management subsystem to reward the participant if the check-in signal is received within the time window for action, the algorithm comprising:
determining a check-in time for the check-in signal;
utilizing the unique identifier to access the corresponding participant profile in the database;
utilizing the link between the participant profile and the multiple participant attendance challenge to determine the corresponding time window for action for the participant;
comparing the check-in time with the time window for action; and
assigning and storing an in-attendance result to the multiple participant attendance challenge if the check-in time is within the time window for action; and
providing a reward to the participant for meeting the attendance challenge by achieving an in-attendance result.

16. The electronic system of claim 15, wherein the reward to the participant for meeting the attendance challenge is selected from the group consisting of a monetary amount, a non-monetary prize, a voucher, a credit, a coupon, a discount, a product, an object, a trip, a service, and a certificate.

17. The electronic system of claim 15, wherein the electronic system is a stand-alone kiosk containing the data management subsystem, the processor and the interface.

18. The electronic system of claim 15, wherein the electronic system further comprises a plurality of kiosks located at various locations, each with a means for sending the check-in signal containing the unique identifier to the interface.

19. The electronic system of claim 15, further comprising a server, wherein the server contains the data management subsystem, the processor and the interface and the signals are received from the Internet.

20. The electronic system of claim 15, wherein the check-signals are received from a communication system.
